(19) United States
(12) Patent Application Publication
(10) Pub. No.: US 2018/0072909 A1
(43) Pub. Date: Mar. 15, 2018

(54) SELF-THICKENING LATEX FOR WATERBORNE SYSTEMS AND RELATED METHODS

(71) Applicant: RHODIA OPERATIONS, Paris (FR)

(72) Inventors: Lichang ZHOU, Lawrenceville, NJ (US); Adnan SIDDIQUI, Tenafly, NJ (US); Homayoun JAMASBI, Lansdale, PA (US); David James WILSON, Coye la Foret (FR); Pierre-Emmanuel DUFILS, Paris (FR); Tiffany CHEN, Newark, DE (US); Fabio TREZZI, Puteaux (FR)

(73) Assignee: RHODIA OPERATIONS, Paris (FR)

(21) Appl. No.: 15/699,071

(22) Filed: Sep. 8, 2017

Related U.S. Application Data
(60) Provisional application No. 62/385,706, filed on Sep. 9, 2016.

(51) Int. Cl. C09D 113/02; C09D 7/12

(52) U.S. Cl. CPC C09D 113/02; C08K 3/26; C09D 7/1216

(57) ABSTRACT

Coatings and other applications containing latex having self-thickening properties obtainable by methods of adding a water soluble amphiphilic copolymer in a aqueous dispersion of a water-insoluble polymer obtained from ethylenically unsaturated monomers.

### CROSS-REFERENCE TO RELATED APPLICATIONS

This application claims the benefit of U.S. Provisional Patent Application No. 62/385,706 filed Sep. 9, 2016, incorporated herein by reference in its entirety.

### FIELD OF THE INVENTION

This invention relates to improved coatings and latex having improved properties including but not limited to self-thickening properties and, in particular, to improved latexes prepared by utilizing hydrophilic precursors with a Xanthate moiety (or other chain-transfer agent or “CTA”) in emulsion polymerization without the need for emulsifying surfactants.

### BACKGROUND OF THE INVENTION

Latexes are colloidal dispersions of polymer particles in water, produced by emulsion polymerization. Latexes are used in a broad range of applications, and offers considerable advantages for industrial synthesis. They represent an attractive alternative to solvent-based formulations. However, several drawbacks remain associated with traditional latex-based coatings and processes. Latex paints generally have very low viscosity without the use of thickeners. Low viscosity can cause problems such as low stability, uneven application and sag/dripping during applications. Thickeners have therefore been used in latex paint to increase viscosity and provide stability in paint and coating applications. Thickeners also help to improve anti-settling of pigment and improve sag resistance. These thickeners added extra cost to the paint, and negatively impacted the performance such as reduced block resistance and stain resistance.

### SUMMARY OF INVENTION

Latexes, as described herein, are made without the use of a surfactant, but by inducing molecular self-assembly of polymeric emulsifier particles prepared by RAFT. In another embodiment, latexes, as described herein, are made with little or no added surfactant, but by inducing molecular self-assembly of polymeric emulsifier particles prepared by RAFT.

It has been surprisingly discovered that emulsion polymerization of hydrophobic monomers can be performed directly in batch ab initio conditions using water-soluble macro-RAFT/MADIX agents. In such conditions, amphiphilic block copolymers form and self-assemble into self-stabilized particles within the course of the polymerization by polymerization-induced self-assembly (PISA). This process solves the problems met during the attempts to implement RAFT/MADIX in ab initio emulsion such as loss of molecular weight control, loss of colloidal stability, and/or formation of an intractable oily layer. The PISA process allows the synthesis of latexes without using low molecular weight surfactants avoiding the problems induced by these products

It has been also demonstrated that the nano-objects obtained during polymerization by PISA may give polymer films that resist to organic solvents due to strong hydrogen bonding between the hydrophilic blocks, and to water even after 72 hours of immersion.

Latex is an example of an emulsion polymer which is water based polymer dispersion. Latex paints are used for a variety of applications including interior and exterior, and flat, semi-gloss and gloss applications. Latex is a stable dispersion (colloidal emulsion) of rubber or plastic polymer microparticles in an aqueous medium. Latexes may be natural or synthetic.

PISA (Polymerization Induced Self-Assembly) as used in the process to prepare latexes allows the preparation of latexes in the absence of surfactants, by using hydrophilic macromolecular chain transfer agents instead. As a result, latexes prepared by using these hydrophilic compounds in place of traditional surfactants showed an improvement of water resistance, scrub resistance, and/or stain resistance, among other benefits.

The latexes prepared herein also exhibited self-thickening properties when pH was adjusted from low pH to a pH above 7. This enables paint formulators to formulate paint without using thickeners. The thickener-free paint also exhibits improved block and stain resistance.

The at least one latex polymer in the aqueous coating composition can be a pure acrylic, a styrene acrylic, a vinyl acrylic or an acrylated ethylene vinyl acetate copolymer, an ethylene vinyl acetate copolymer and is more preferably a pure acrylic or ethylene vinyl acetate (VAE) copolymer. The at least one latex polymer is preferably derived from at least one acrylic monomer selected from the group consisting of acrylic acid, acrylic acid esters, methacrylic acid, and methacrylic acid esters. For example, the at least one latex polymer can be a butyl acrylate/methyl methacrylate copolymer or a 2-ethylhexyl acrylate/methyl methacrylate copolymer. Typically, the at least one latex polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C₄-C₈ conjugated dienes.

In one embodiment, the at least one latex polymer is preferably derived from at least one monomer selected from vinyl acetate and ethylene vinyl acetate VAE, and further comprising at least one second monomer selected from: methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, hydroxyethyl (meth)acrylate, hydroxypropyl (meth)acrylate, methoxyethyl (meth)acrylate, ethoxyethyl (meth)acrylate, phenoxyethyl (meth)acrylate, tetrahydrofurfuryl (meth)acrylate, glycidyl (meth)acrylate, dimethylaminoethyl (meth)acrylate, diethylaminoethyl (meth)acrylate, tert-butylaminoethyl (meth)acrylate, and acetoxyethyl (meth)acrylate, (meth)acrylamide, N-methylol (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, and diacetone (meth)acrylamide, vinyl propionate, vinyl 2-ethylhexanoate, N-vinylpyrrolidione, N-vinylcaprolactam, N-vinylformamide, N-vinylacetamide, methyl vinyl ether, ethyl vinyl ether, butyl vinyl ether, hydroxybutyl vinyl ether, styrene, maleic acid, fumaric acid, butyl methyl maleate, vinyl sulfonic acid, 2-acrylamido-2-methylpropane sulfonic acid, styrene sulfonic acid, vinyl phosphonic acid, allyl phosphonic acid, salts thereof, and mixtures thereof.

Latex paint formulations typically comprise additives, e.g., at least one pigment. In a preferred embodiment of the invention the latex paint formulation includes at least one pigment selected from the group consisting of TiO2, CaCO3, clay, aluminum oxide, silicon dioxide, magnesium oxide, sodium oxide, potassium oxide, talc, barytes, zinc oxide, zinc sulfite and mixtures thereof. More preferably the at least one pigment includes TiO2, calcium carbonate or clay.

In addition to the above components, the aqueous coating composition can include one or more additives selected from the group consisting of dispersants, defoamers, biocides, mildewcides, colorants, waxes, perfumes and co-solvents.

Compositions of the present invention may have an absence of one or more of anionic surfactant, cationic surfactant, nonionic surfactant, zwitterionic surfactant, and/or amphoteric surfactant. Typically, surfactants are used to prepare the seed or emulsion polymer latexes and, as such, surfactants play a crucial role in the formation of emulsion polymer latexes. Once the latex has been formed, however, surfactants remaining in the formulation can be detrimental in the final application or coating. For example, one drawback in having surfactant remaining in the formulation is surfactant blooming or surfactant blushing. Surfactant blooming, or blushing, occurs when a film is contacted with water and the surfactant migrates. This can result in the film becoming hazy, an undesirable property.

It is also believed that excess surfactant results in low water resistivity to the final coating application. Post-polymerization mobility of the surfactants is yet another problem associated with the use of surfactant during emulsion polymerization of the latex. For example, surfactants can migrate from the surface of latex particles to the liquid-air interface or from the surface of a formed latex film. It is desirable to minimize the adverse effects of surfactants in water borne emulsion polymer latex applications.

In one aspect, described herein are processes for preparing an aqueous polymer dispersion, the process comprising free radical polymerizing ethylenically unsaturated monomers in the presence of at least one free radical initiator and at least one compound of formula (I) in an aqueous polymerization medium; wherein the aqueous polymer dispersion is substantially free of added rheology modifiers, wherein the aqueous polymer dispersion is characterized by a viscosity of less than or equal to 70 KU at a pH lower than about 5.0, but a viscosity of greater or equal to 85 KU upon adjustment to a pH of about 6.5 or higher.

In another aspect, described herein are coating compositions comprising: a latex composition with modified surface chemistry obtained by free-radical emulsion polymerization in the presence:

of at least one ethylenically unsaturated monomer or at least one polymer containing residual ethylenically unsaturated bonds comprising: methyl acrylate, ethyl acrylate, methyl methacrylate, butyl acrylate, 2-ethyl hexyl acrylate, acrylic acid, methacrylic acid, styrene, vinyl toluene, vinyl acetate, vinyl versatate, ethylene vinyl acetate (VAE), acrylonitrile, acrylamide, butadiene, ethylene, vinyl chloride, and mixtures thereof,

of at least one free-radical polymerization initiator, and

of at least one water-soluble and/or water-dispersible monoblock, diblock or triblock polymer comprising formula (I):

(R¹¹)x-Z¹¹—C(═S)—Z¹²-[A]-R¹² (I)

wherein:
Z¹¹ represents C, N, O, S or P,
Z¹² represents S or P,
R¹¹ and R¹², which may be identical or different, represent:
   an optionally substituted alkyl, acyl, aryl, alkene or alkyne group (i), or
   a saturated or unsaturated, optionally substituted or aromatic carbon-based ring (ii), or
   a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R representing an alkyl or aryl group,
x corresponds to the valency of Z¹¹, or alternatively x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR₂); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts); and A represents a monoblock, diblock or triblock polymer comprising at least a first block which is hydrophilic in nature and an optional second block which is hydrophobic or hydrophilic in nature, wherein the coating composition is substantially free of added rheology modifiers.
   In one embodiment, the coating compositions as described herein further contain a pigment.

These and other features and advantages of the present invention will become more readily apparent to those skilled in the art upon consideration of the following detailed description, which describe both the preferred and alternative embodiments of the present invention.

### BRIEF DESCRIPTION OF DRAWINGS

FIG. 1 showed a chart of viscosity vs pH in a PISA-based latex composition.

### DETAILED DESCRIPTION OF INVENTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl, 2-ethylhexyl.

As used herein, the term “aryl” means a monovalent unsaturated hydrocarbon radical containing one or more six-membered carbon rings in which the unsaturation may be represented by three conjugated double bonds, which may be substituted with one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cr-Cs)” in reference to an organic group, wherein r and s are each integers, indicates that the group may contain from r carbon atoms to s carbon atoms per group.

As used herein the term “(meth)acrylate” refers collectively and alternatively to the acrylate and methacrylate and the term “(meth)acrylamide” refers collectively and alternatively to the acrylamide and methacrylamide, so that, for example, “butyl (meth)acrylate” means butyl acrylate and/or butyl methacrylate.

As used herein, “molecular weight” in reference to a polymer or any portion thereof, means to the weight-average molecular weight (“Mw”) of the polymer or portion. Mw of a polymer is a value measured by gel permeation chromatography (GPC) with an aqueous eluent or an organic eluent (for example dimethylacetamide, dimethylformamide, and the like), depending on the composition of the polymer, light scattering (DLS or alternatively MALLS), viscometry, or a number of other standard techniques. Mw of a portion of a polymer is a value calculated according to known techniques from the amounts of monomers, polymers, initiators and/or transfer agents used to make the portion.

As used herein, each of the terms “monomer”, “polymer”, “homopolymer”, “copolymer”, “linear polymer”, “branched polymer”, “star polymer”, “comb polymer”, “random copolymer”, alternating copolymer”, “block copolymer”, “graft copolymer”, has the meaning ascribed to it in Glossary of basic terms in polymer science (IUPAC Recommendations 1996), Pure Appl. Chem., Vol. 68, No. 12, pp. 2287-2311, 1996.

As used herein, the indication that a radical may be “optionally substituted” or “optionally further substituted” means, in general, unless further limited, either explicitly or by the context of such reference, such radical may be substituted with one or more inorganic or organic substituent groups, for example, alkyl, alkenyl, aryl, arylalkyl, alkaryl, a hetero atom, or heterocyclyl, or with one or more functional groups capable of coordinating to metal ions, such as hydroxyl, carbonyl, carboxyl, amino, imino, amido, phosphonic acid, sulphonic acid, or arsenate, or inorganic and organic esters thereof, such as, for example, sulphate or phosphate, or salts thereof.

As used herein, “parts by weight” or “pbw” in reference to a named compound refers to the amount of the named compound, exclusive, for example, of any associated solvent. For example, a reference to “10 pbw cocoamidopropylbetaine” means 10 pbw of the actual betaine compound, added in the form of a commercially available aqueous solution of the betaine compound, exclusive of the water contained in the aqueous solution.

As used herein, an indication that a composition is “substantially free” of a specific material, means the composition contains no more than an insubstantial amount of that material, and an “insubstantial amount” means an amount that does not measurably affect the desired properties of the composition.

As used herein, the term “surfactant” means a compound that reduces surface tension when dissolved in water.

As used herein, suitable polymerizable functional groups include, for example, acrylo, methacrylo, acrylamido, methacrylamido, diallylamino, allyl ether, vinyl ether, α-alkenyl, maleimido, styrenyl, and α-alkyl styrenyl groups.

As used herein, the term “Macro CTA” means the structure according to formula (I), below.

Latex (emulsion polymer) is used commonly and widely in paints and coatings, adhesives, sealants and elastomeric applications. Typical preparation for the industrial production of latex polymers involves the use of monomers from styrene, butyl acrylate, and ethyl hexyl acrylate to vinyl acetate to gaseous monomers such as ethylene, plus typical initiators such as ammonium persulfate etc. and surfactants to stabilize the latex particles ranging from 40 to 500 nm (typically 80-250 nm).

The amount of surfactant used to make the latex can range between 1-3% based on the total amount of monomers. Surfactants are used to not only control the particle size but also to provide shear stability and therefore play a crucial in preparation of latexes and long term shelf stability of the latex.

However, such use of surfactants are at times outweighed by the need to minimize the surfactant levels to obtain films of latex that can give excellent water resistance together with adhesion to substrates. The importance of eliminating or reducing surfactants therefore becomes critical and more critical in paint films (with low or high PVC) as the presence of surfactants tends to diminish the aesthetic appearance of the paint film (blistering, leaching, craters etc.).

To improve the water resistance of latex films and that of paint films in particular especially for latex polymers based on co-polymers of vinyl acetate, or co-polymers of styrene acrylates, the usage of surfactant has been minimized or attempts have been made using polymerizable surfactants. In both cases results have not been satisfactory in obtaining good water resistance or other performance properties.

In one embodiment, the use of the Macro CTA as described herein (hydrophilic precursors with Xanthate moiety) in emulsion polymerization of latexes, in particular latex polymers of vinyl acetate with other co-monomers and also of styrene with other co-monomers have been prepared to yield stable latexes with particle size ranging from 80-200 nm. Films of the latex polymers show surprisingly exceptional water resistance as measured through a variety of test methods for water resistance namely the water droplet, water immersion and water vapor tests. The films of the above prepared latex with Macro CTA for example were tested by the water immersion test by soaking the film of the latex in water for up to 8 days and monitoring for blushing (whiteness) or any other film defects, and by the water vapor method for an hour against film of commercial latexes and latexes produced using standard surfactants.

The film of latex based on commercial latex and those with surfactants prepared in the laboratory blush after 24 hours and the blush (whiteness) of the film becomes progressively deeper over time while the film of latex based on co-polymers of vinyl acetate or styrene acrylic show no tendency toward whiteness even after 8 days of allowing the films to soak in water.

Latexes prepared using Macro CTA and based on co-polymers of vinyl acetate and those of co-monomers with styrene—compared to latexes based on surfactants—have shown enhanced shear stability, freeze thaw and electrolyte stability and films of the latex show enhanced adhesion to metallic substrate.

The above prepared latex with Macro CTA containing Xanthate moiety of invention can easily be scaled for commercial purposes. The preparation of the seed of above latex polymers (vinyl acetate co-polymers and or of styrene copolymers), which is part of the preparation in making latexes of high solids are also desirable.

The described Macro CTAs and the array of Macro CTA with the use of specialty monomers that are available allow for tailoring of latexes for various performances and multifunctional performance and thereby extending the application beyond just paints and coating applications, which include but are not limited to coatings, adhesives, sealants, elastomeric applications, and the like.

The latex of the present invention comprises, in dispersion, a water-insoluble polymer obtained from monomers comprising ethylenic unsaturation. The monomers as mentioned herein can be used as ethylenically unsaturated monomers involved in the production of the latex. Latexes with modified surface properties, which can be obtained using a method which comprises addition of a water-soluble amphiphilic copolymer to an aqueous dispersion of a water-insoluble polymer or copolymer obtained from monomers with ethylenic unsaturation.

In one embodiment, the latexes can be used as binding agents in various applications in the fields of paint, papermaking coating, coatings and construction materials.

In one embodiment, a non-surfactant copolymer can be obtained through the choice of monomers, for example the Styrene/BA copolymer is non-surfactant. It is also possible to obtain a non-surfactant block copolymer by increasing the molecular mass or by decreasing the fraction of hydrophobic monomers in the copolymer.

In general, the water-soluble amphiphilic block copolymers described above can be obtained by any polymerization process referred to as “living” or “controlled”, such as, for example:

free-radical polymerization controlled by xanthates, according to the teaching of application WO 98/58974,

free-radical polymerization controlled by dithioesters, according to the teaching of application WO 97/01478,

polymerization using nitroxide precursors, according to the teaching of application WO 99/03894,

free-radical polymerization controlled by dithiocarbamates, according to the teaching of application WO 99/31144, and/or

atom transfer free-radical polymerization (ATRP), according to the teaching of application WO 96/30421.

The term “Macro CTA” is defined by Formula (I) below.

A monoblock, diblock or triblock polymer corresponds to the following formula (I):

(R¹¹)x-Z¹¹—C(═S)—Z¹²-[A]-R¹² (I)

in which formula:

Z¹¹ represents C, N, O, S or P,

Z¹² represents S or P,

R¹¹ and R¹², which may be identical or different, represent:
a an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R respresenting an alkyl or aryl group,

x corresponds to the valency of Z¹¹, or alternatively

x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR₂); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts);

A represents a monoblock, diblock or triblock polymer.

According to one advantageous variant of the invention, the compound of formula (I) is such that Z¹¹ is an oxygen atom and Z¹² is a sulphur atom. These compounds are thus functionalized at the end of the chain with xanthates.

As regards the polymer A, it corresponds more particularly to at least one of the three formulae below:

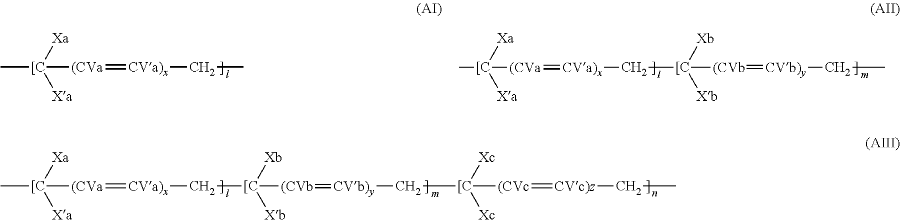

in which formulae:
Va, V′a, Vb, V′b, Vc and V′c, which may be identical or different, represent: H, an alkyl group or a halogen,
Xa, X′a, Xb, X′b, Xc and X′c, which may be identical or different, represent H, a halogen or a group R, OR, OCOR, NHCOH, OH, NH2, NHR, N(R)₂, (R)₂N⁺O⁻, NHCOR, CO₂H, CO₂R, CN, CONH₂, CONHR or CONR₂, in which R, which may be identical or different, are chosen from alkyl, aryl, aralkyl, alkaryl, alkene and organosilyl groups, optionally perfluorinated and optionally substituted with one or more carboxyl, epoxy, hydroxyl, alkoxy, amino, halogen or sulphonic groups,
l, m and n, which may be identical or different, are greater than or equal to 1,
x, y and z, which may be identical or different, are equal to 0 or 1.

More particularly, the polymer A is obtained by using at least one ethylenically unsaturated monomer chosen from hydrophilic monomers.

Examples of such monomers that may especially be mentioned include
ethylenically unsaturated monocarboxylic and dicarboxylic acids, for instance acrylic acid, methacrylic acid, itaconic acid, maleic acid or fumaric acid,
monoalkyl esters of dicarboxylic acids of the type mentioned with alkanols preferably containing 1 to 4 carbon atoms, and N-substituted derivatives thereof, such as, 2-hydroxyethyl acrylate or methacrylate,
unsaturated carboxylic acid amides, for instance acrylamide or methacrylamide,
ethylenic monomers comprising a sulphonic acid group and ammonium or alkali metal salts thereof, for example vinylsulphonic acid, vinylbenzenesulphonic acid, α-acrylamidomethyl propanesulphonic acid or 2-sulphoethylene methacrylate,
vinyl phosphonic acid,
vinyl sulphonate and salts thereof,

It is possible to incorporate into the polymer composition a proportion of hydrophobic monomers, provided that the solubility/dispersity conditions and the conditions of non-formation of gelled or non-gelled micelles, mentioned previously, remain valid.

Illustrations of hydrophobic monomers that may especially be mentioned include styrene or its derivatives, butadiene, chloroprene, (meth)acrylic esters, vinyl esters and vinyl nitriles.

The term “(meth)acrylic esters” denotes esters of acrylic acid and of methacrylic acid with hydrogenated or fluorinated C₁-C₁₂ and preferably C₁-C₈ alcohols. Among the compounds of this type that may be mentioned are: methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate.

The vinyl nitriles more particularly include those containing from 3 to 12 carbon atoms, such as, in particular, acrylonitrile and methacrylonitrile.

It should be noted that the styrene may be totally or partially replaced with derivatives such as α-methylstyrene or vinyltoluene.

The other ethylenically unsaturated monomers that may be used, alone or as mixtures, or that are copolymerizable with the above monomers are especially:
vinyl esters of a carboxylic acid, for instance vinyl acetate, vinyl versatate or vinyl propionate,
vinyl halides,
vinylamine amides, especially vinylformamide or vinylacetamide,
ethylenically unsaturated monomers comprising a secondary, tertiary or quaternary amino group, or a heterocyclic group containing nitrogen, such as, for example, vinylpyridines, vinylimidazole, aminoalkyl (meth)acrylates and aminoalkyl(meth)acrylamides, for instance dimethylaminoethyl acrylate or methacrylate, di-tert-butylaminoethyl acrylate or methacrylate, dimethylaminomethylacrylamide or dimethylaminomethylmethacrylamide. It is likewise possible to use zwitterionic monomers such as, for example, sulphopropyl (dimethyl)aminopropyl acrylate.

According to one particularly advantageous embodiment, the polymer A is a monoblock or a diblock polymer.

It should moreover be noted that the polymer A more particularly has a number-average molar mass of less than 20,000 and preferably less than 10,000. In one embodiment, polymer A has a number-average molar mass of between about 1,000 to about 7,000. These molar masses are measured by size exclusion chromatography, using polyethylene glycol as standard.

In one embodiment, the polymer A or the Macro CTA has a weight average molecular weight of less than 30,000, typically less than 15,000. In one embodiment, polymer A or the Macro CTA has a weight average molecular weight of between about 1,500 to about 10,000.

According to a second embodiment of the invention, the monoblock, diblock or triblock polymer used is a polymer corresponding to the following formulae:

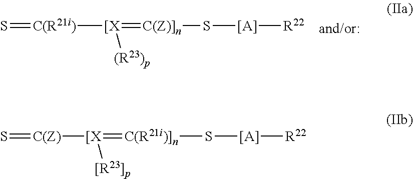

in which formulae:
X represents an atom chosen from N, C, P and Si,
R22 represents:
   an optionally substituted alkyl, acyl, aryl, alkene or alkyne group (i), or
   a saturated or unsaturated, optionally substituted or aromatic carbon-based ring (ii), or
   a saturated or unsaturated, optionally
   substituted or aromatic heterocycle (iii), these groups and rings (i), (ii) and (iii) possibly being substituted with substituted phenyl groups, substituted aromatic groups or groups:
   alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, organosilyl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
   R representing an alkyl or aryl group,
Z, R²¹ⁱ and R²³, which may be identical or different, are chosen from:
   a hydrogen atom,
   an optionally substituted alkyl, acyl, aryl, alkene or alkyne group,
   a saturated or unsaturated, optionally substituted or aromatic carbon-based ring,
   a saturated or unsaturated, optionally substituted heterocycle,
   alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR2), halogen, allyl, epoxy, alkoxy (—OR), S-alkyl, S-aryl and organosilyl groups, R representing an alkyl or aryl group,
   groups of hydrophilic or ionic nature such as the alkali metal salts of carboxylic acids, the alkali metal salts of sulphonic acid, polyalkylene oxide (PEO or PPO) chains and cationic substituents (quaternary ammonium salts).
n>0,
i ranges from 1 to n,
B p is equal to 0, 1 or 2 depending on the valency of X, and also
if X=C, then Z is not an S-alkyl or S-aryl group,
the group R¹ⁱ, where i=n, is not an S-alkyl or S-aryl group,
A represents a monoblock, diblock or triblock polymer as defined herein.

In order to obtain water-soluble amphiphilic copolymers comprising hydrophilic and hydrophobic blocks, this process consists in forming a first block according to the following steps:

(1) bringing into contact:
at least one ethylenically unsaturated monomer,
at least one source of free radicals, and
at least one compound of formula (I) as described herein;

(2) forming a second block by repeating step 1 using: monomers which are different in nature, and in place of the precursor compound of formula (I), the polymer derived from step 1; and

(3) Optionally hydrolyzing, at least partially, the copolymer obtained.

During step 1, a first block of the polymer is synthesized which is mainly hydrophilic or hydrophobic in nature depending on the nature and the amount of the monomers used. During step 2, the other block of the polymer is synthesized.

The ethylenically unsaturated monomers can be chosen from the hydrophilic, hydrophobic and hydrolyzable monomers defined herein, in proportions suitable for obtaining a block copolymer in which the blocks exhibit the characteristics defined above.

According to this process, if all the successive polymerizations are carried out in the same reactor, it is generally preferable for all the monomers used in a step to be consumed before the polymerization of the subsequent step begins, therefore before the new monomers are introduced. However, it may so happen that the hydrophobic or hydrophilic monomers of the preceding step are still present in the reactor during the polymerization of the subsequent block. In this case, these monomers generally represent no more than 5 mol % of all the monomers and they participate in the polymerization by contributing to the introduction of the hydrophobic or hydrophilic units into the subsequent block.

A water-soluble amphiphilic copolymer comprising blocks which are hydrophilic in nature and which are hydrophobic in nature can be obtained from a single type of hydrophobic hydrolyzable monomer. In this case, step 2 is no longer necessary, but partial hydrolysis of the polymer is then essential.

Using the same process, it is possible to obtain a copolymer comprising n blocks by repeating the preceding steps 1 and 2, but replacing the compound of formula (I) with the copolymer comprising n−1 blocks.

In one embodiment, the copolymers obtained by the processes described above generally exhibit a polydispersity index of at most 2, typically of at most 1.5. It may be desired to mix with the latex blocks whose polydispersity is controlled. In this case, it is possible to mix, in precise proportions, several water-soluble amphiphilic copolymers comprising a block which is hydrophilic in nature and a block which is hydrophobic in nature, each having a clearly defined molecular mass.

In one embodiment, described herein are methods of preparing an aqueous coating composition by mixing together at least one latex polymer derived from at least one monomer and the Macro CTA as described herein and at least one pigment. Preferably, the latex polymer is in the form of latex polymer dispersion. The additives discussed above can be added in any suitable order to the latex polymer, the pigment, or combinations thereof, to provide these additives in the aqueous coating composition. In the case of paint formulations, the aqueous coating composition preferably has a pH of from 7 to 10. In one embodiment, the coating or paint can be thickened without the traditional use of a thickener or rheology modifier. In one embodiment, the latex or coating self-thickens when pH was adjusted from low pH to pH above 7, which would allow formulating paint without using thickeners. The paint also showed improved block resistance and stain resistance. In one embodiment, the coating composition can be thickened to about 85-125 KU. In another embodiment, the coating composition can be thickened above 85 KU. In yet another embodiment, the coating composition can be thickened to about 90-120 KU

Low pH in one embodiment means a pH of less than or equal to 6, 5 or 4. In another embodiment, low pH means a pH of less than or equal to 3 or 2. In another exemplary embodiment, low pH means a pH of less than or equal to 6, 5.5, 5, or 4.5.

In one embodiment, described herein are processes for preparing an aqueous polymer dispersion, the process comprising free radical polymerizing ethylenically unsaturated monomers in the presence of at least one free radical initiator and at least one compound of formula (I) in an aqueous polymerization medium;

wherein the aqueous polymer dispersion is characterized by a viscosity of having a lower limit of 75 KU, or 70 KU, or 65 KU at a pH lower than about 5.0, but a viscosity of greater or equal to 85 KU, or 90 KU, or 95 KU upon adjustment to a pH of about 6.5 or higher.

In formulating latexes and latex paints/coatings, physical properties that may be considered include, but are not limited to, viscosity versus shear rate, ease of application to surface, spreadability, and shear thinning.

When hydrolyzable hydrophobic monomers are used, the hydrolysis may be carried out using a base or an acid. The base can be chosen from alkali metal or alkaline earth metal hydroxides, such as sodium hydroxide or potassium hydroxide, alkali metal alkoxides, such as sodium methoxide, sodium ethoxide, potassium methoxide, potassium ethoxide or potassium t-butoxide, ammonia and amines, such as triethylamines. The acids can be chosen from sulfuric acid, hydrochloric acid and para-toluenesulfonic acid. Use may also be made of an ion-exchange resin or an ion-exchange membrane of the cationic or anionic type. The hydrolysis is generally carried out at a temperature of between 5 and 100° C., preferably between 15 and 90° C. Preferably, after hydrolysis, the block copolymer is washed, for example by dialysis against water or using a solvent such as alcohol. It may also be precipitated by lowering the pH below 4.5.

The hydrolysis may be carried out on a single-block polymer, which will subsequently be associated with other blocks, or on the final block polymer.

The latex of the present invention comprises, in dispersion, a water-insoluble polymer obtained from monomers comprising ethylenic unsaturation. All the monomers which had been mentioned in the context of the definition of the water-soluble amphiphilic copolymer can be used as monomers comprising ethylenic unsaturations involved in the production of the latex. Reference may therefore be made to this part of the description for choosing a useful monomer comprising ethylenic unsaturation.

The monomers typically employed in emulsion polymerization to make latex for latex paint include, but are not limited to such monomers as methyl acrylate, ethyl acrylate, methyl methacrylate, butyl acrylate, 2-ethyl hexyl acrylate, other acrylates, methacrylates and their blends, acrylic acid, methacrylic acid, styrene, vinyl toluene, vinyl acetate, vinyl esters of higher carboxylic acids than acetic acid, e.g. vinyl versatate, acrylonitrile, acrylamide, butadiene, ethylene, vinyl chloride and the like, and mixtures thereof. This is further discussed below in the section entitled “Latex Monomers”.

In one embodiment, the latex monomers fed to a reactor to prepare the polymer latex binder preferably include at least one acrylic monomer selected from the group consisting of acrylic acid, acrylic acid esters, methacrylic acid, and methacrylic acid esters. In addition, the monomers can include styrene, vinyl acetate, or ethylene. The monomers can also include one or more monomers selected from the group consisting of styrene, (alpha)-methyl styrene, vinyl chloride, acrylonitrile, methacrylonitrile, ureido methacrylate, vinyl acetate, vinyl esters of branched tertiary monocarboxylic acids (e.g. vinyl esters commercially available under the mark VEOVA from Shell Chemical Company or sold as EXXAR neo vinyl esters by ExxonMobil Chemical Company), itaconic acid, crotonic acid, maleic acid, fumaric acid, and ethylene. It is also possible to include C4-C8 conjugated dienes such as 1,3-butadiene, isoprene or chloroprene. Commonly used monomers in making acrylic paints are butyl acrylate, methyl methacrylate, ethyl acrylate and the like. Preferably, the monomers include one or more monomers selected from the group consisting of n-butyl acrylate, methyl methacrylate, styrene and 2-ethylhexyl acrylate.

The latex polymer is typically selected from the group consisting of pure acrylics (comprising acrylic acid, methacrylic acid, an acrylate ester, and/or a methacrylate ester as the main monomers); styrene acrylics (comprising styrene and acrylic acid, methacrylic acid, an acrylate ester, and/or a methacrylate ester as the main monomers); vinyl acrylics (comprising vinyl acetate and acrylic acid, methacrylic acid, an acrylate ester, and/or a methacrylate ester as the main monomers); and acrylated ethylene vinyl acetate copolymers (comprising ethylene, vinyl acetate and acrylic acid, methacrylic acid, an acrylate ester, and/or a methacrylate ester as the main monomers).

In another embodiment, the latex polymer comprises monomers such as acrylamide and acrylonitrile, and one or more functional monomers such as itaconic acid and ureido methacrylate, as would be readily understood by those skilled in the art. In a particularly preferred embodiment, the latex polymer is a pure acrylic such as a butyl acrylate/methyl methacrylate copolymer derived from monomers including butyl acrylate and methyl methacrylate.

In one embodiment, latex polymer comprises:

(a) a first monomer selected from vinyl acetate; and

(b) at least one second monomer selected from: acrylic acid, methacrylic acid, maleic acid, fumaric acid, butyl methyl maleate, vinyl sulfonic acid, 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

In typical acrylic paint compositions the polymer is comprised of one or more esters of acrylic or methacrylic acid, typically a mixture, e.g. about 50/50 by weight, of a high Tg monomer (e.g. methyl methacrylate) and a low Tg monomer (e.g. butyl acrylate), with small proportions, e.g. about 0.5% to about 2% by weight, of acrylic or methacrylic acid. The vinyl-acrylic paints usually include vinyl acetate and butyl acrylate and/or 2-ethyl hexyl acrylate and/or vinyl versatate. In vinyl-acrylic paint compositions, at least 50% of the polymer formed is comprised of vinyl acetate, with the remainder being selected from the esters of acrylic or methacrylic acid. The styrene/acrylic polymers are typically similar to the acrylic polymers, with styrene substituted for all or a portion of the methacrylate monomer thereof.

The latex polymer dispersion preferably includes from about 30 to about 75% solids and a mean latex particle size of from about 70 to about 650 nm. The latex polymer is preferably present in the aqueous coating composition in an amount from about 5 to about 60 percent by weight, and more preferably from about 8 to about 40 percent by weight (i.e. the weight percentage of the dry latex polymer based on the total weight of the coating composition).

The aqueous coating composition is a stable fluid that can be applied to a wide variety of materials such as, for example, paper, wood, concrete, metal, glass, ceramics, plastics, plaster, and roofing substrates such as asphaltic coatings, roofing felts, foamed polyurethane insulation; or to previously painted, primed, undercoated, worn, or weathered substrates. The aqueous coating composition of the invention can be applied to the materials by a variety of techniques well known in the art such as, for example, brush, rollers, mops, air-assisted or airless spray, electrostatic spray, and the like.

Liquid Carrier

In one embodiment, the composition of the present invention (for example paints or stains) comprises the selected polymer and a liquid carrier.

In one embodiment, the liquid carrier is an aqueous carrier comprising water and the treatment solution is in the form of a solution, emulsion, or dispersion of the material and additives. In one embodiment, the liquid carrier comprises water and a water miscible organic liquid. Suitable water miscible organic liquids include saturated or unsaturated monohydric alcohols and polyhydric alcohols, such as, for example, methanol, ethanol, isopropanol, cetyl alcohol, benzyl alcohol, oleyl alcohol, 2-butoxyethanol, and ethylene glycol, as well as alkylether diols, such as, for example, ethylene glycol monoethyl ether, propylene glycol monoethyl ether and diethylene glycol monomethyl ether.

As used herein, terms “aqueous medium” and “aqueous media” are used herein to refer to any liquid medium of which water is a major component. Thus, the term includes water per se as well as aqueous solutions and dispersions.

Ethylenically Unsaturated Monomers

In one embodiment, the reactive group of the additional associative monomer is an ethylenically unsaturated group and the monomer is an ethylenically unsaturated monomer comprising at least one site of ethylenic unsaturation, more typically, an α-, β-unsaturated carbonyl moiety, and at least one group according to structure (D.XXI) per molecule and copolymerizable with the acidic monomer and the non-ionic monomer.

In one embodiment, the optional additional associative monomer comprises one or more compounds according to structure (D.XXIII):

R²⁴—R²³—R²²—R²¹ (D.XXIII)

wherein:

R²¹, R²², and R²³ are each as described above, and

R²⁴ is a moiety having a site of ethylenic unsaturation. Thus the resulting hydrophobic monomeric unit has the structure (D.XXIV):

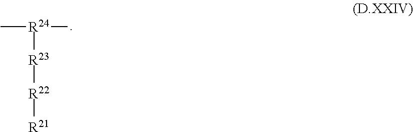

In one embodiment, the compound according to structure (D.XXI) is an α-, β-unsaturated carbonyl compound. In one embodiment, R²³ is according to structure (D.X).

In one embodiment, the additional associative monomer comprises one or more compounds according to structure (D.XXV):

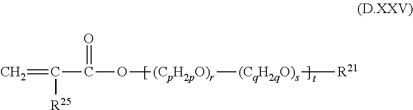

wherein

R²¹ is linear or branched (C₅-C₅₀)alkyl, hydroxyalkyl, alkoxyalkyl, aryl, or arylalkyl,
R²⁵ is methyl or ethyl, and
p and q are independently integers of from 2 to 5, more typically 2 or 3,
each r is independently an integer of from 1 to about 80, more typically from 1 to about 50,
each s is independently an integer of from 0 to about 80, more typically from 0 to about 50,
t is an integer of from 1 to about 50, provided that the product obtained by multiplying the integer t times the sum of r+s is from 2 to about 100; or p, q, r, s, and t are each as otherwise described above.

In one embodiment, the additional associative monomer comprises one or more compounds according to structure (D.XXV) wherein R²¹ is linear (C₁₆-C₂₂)alkyl.

In one embodiment, the optional additional associative monomer comprises one or more compounds according to structure (D.XXV) wherein R²¹ is a branched (C₅-C₅₀)alkyl group, more typically a branched (C₅-C₅₀)alkyl group according to structure (D.VIII). For example R²¹ may have the structure D.XXVI

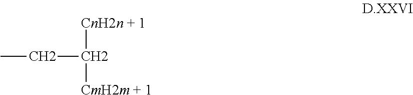

wherein m and n each, independently, are positive integers from 1 to 39 and m+n represents an integer from 4 to 40, as disclosed by US Patent Application Publication 2006/02700563 A1 to Yang et al, incorporated herein by reference.

In one embodiment, the optional additional associative monomer comprises one or more compounds according to structure (D.XXV) wherein p=2, s=0, and t=1.

In one embodiment, the optional additional associative monomer comprises one or more compounds according to structure (D.XXV) wherein R²¹ is linear (C₁₆-C₂₂)alkyl, R²⁵ is methyl or ethyl, p=2, s=0, and t=1.

Suitable ethylenically unsaturated optional additional associative monomers include:

alkyl-polyether (meth)acrylates that comprise at least one linear or branched (C₅-C₄₀)alkyl-polyether group per molecule, such as hexyl polyalkoxylated (meth)acrylates, tridecyl polyalkoxylated (meth)acrylates, myristyl polyalkoxylated (meth)acrylates, cetyl polyalkoxylated (meth)acrylates, stearyl polyalkoxylated (methyl)acrylates, eicosyl polyalkoxylated (meth)acrylates, behenyl polyalkoxylated (meth)acrylates, melissyl polyalkoxylated (meth)acrylates, tristyrylphenoxyl polyalkoxylated (meth)acrylates, and mixtures thereof,

alkyl-polyether (meth)acrylamides that comprise at least one (C₅-C₄₀)alkyl-polyether substituent group per molecule, such as hexyl polyalkoxylated (meth)acrylamides, tridecyl polyalkoxylated (meth) acrylamides, myristyl polyalkoxylated (meth) acrylamides, cetyl polyalkoxylated (meth)acrylamides, stearyl polyalkoxylated (methyl) acrylamides, eicosyl polyalkoxylated (meth) acrylamides, behenyl polyalkoxylated (meth) acrylamides, melissyl polyalkoxylated (meth) acrylamides and mixtures thereof,

alkyl-polyether vinyl esters, alkyl-polyether vinyl ethers, or alkyl-polyether vinyl amides that comprise at least one (C₅-C₄₀)alkyl-polyether substituent group per molecule such as vinyl stearate polyalkoxylate, myristyl polyalkoxylated vinyl ether, and mixtures thereof,

as well as mixtures of any of the above alkyl-polyether acrylates, alkyl-polyether methacrylates, alkyl-polyether acrylamides, alkyl-polyether methacrylamides, alkyl-polyether vinyl esters, alkyl-polyether vinyl ethers, and/or alkyl-polyether vinyl amides.

In one embodiment, the optional additional associative monomer comprises one or more alkyl-polyalkoxylated (meth)acrylates that comprise one linear or branched (C₅-C₄₀)alkyl-polyethoxylated group, more typically (C₁₀-C₂₂)alkyl-polyethoxylated group per molecule, such as decyl-polyethoxylated (meth)acrylates, tridecyl-polyethoxylated (meth)acrylates, myristyl-polyethoxylated (meth)acrylates, cetyl-polyethoxylated (meth)acrylates, stearyl-polyethoxylated (methyl)acrylates, eicosyl-polyethoxylated (meth)acrylates, behenyl-polyethoxylated (meth)acrylates, even more typically decyl-polyethoxylated methacrylates, tridecyl-polyethoxylated methacrylates, myristyl-polyethoxylated methacrylates, cetyl-polyethoxylated methacrylates, stearyl-polyethoxylated methylacrylates, eicosyl-polyethoxylated methacrylates, behenyl-polyethoxylated methacrylates, and mixtures thereof.

Anionic Monomers

In one embodiment, the acidic monomeric units each independently comprise, per monomeric unit, at least one group according to structure (A.I):

—R³²—R³¹ (A.I)

wherein
R³¹ is a moiety that comprises at least one carboxylic acid, sulfonic acid, or phosphoric acid group, and
R³² is absent or is a bivalent linking group.

In one embodiment, R³² is O, —(CH₂)ₙ—O—, or is according to structure (structure (A.II):

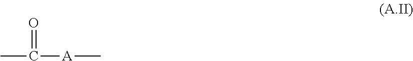

wherein:

n is an integer of from 1 to 6,

A is O or NR¹⁷, and

R¹⁷ is H or (C₁-C₄)alkyl.

In one embodiment, the acidic monomeric units each independently comprise one or two carboxy groups per monomeric unit and may, if the acidic monomeric unit comprises a single carboxy group, further comprise an ester group according to —CH₂COOR³³, wherein R³³ is alkyl, more typically, (C₁-C₆)alkyl.

The acidic monomeric units may be made by known synthesizing techniques, such as, for example, by grafting of one or more groups according to structure (A.I) onto a polymer backbone, such as a hydrocarbon polymer backbone, a polyester polymer backbone, or a polysaccharide polymer backbone. In the alternative, they may be made by polymerizing a monomer comprising a reactive functional group and at least one group according to structure (A.I) per molecule.

In one embodiment, the reactive functional group is an ethylenically unsaturated group so the monomer comprising a reactive functional group is an ethylenically unsaturated monomer. As a result the acidic monomer comprises at least one site of ethylenic unsaturation, more typically, an α-, β-unsaturated carbonyl moiety, and at least one group according to structure (A.I) per molecule and is copolymerizable with the nonionic monomer(s) and the hydrophobic monomer(s).

In one embodiment the acidic monomer comprises one or more ethylenically unsaturated monocarboxylic acid monomers according to structure (A.III):

R³⁴—R³²—R³¹ (A. III)

wherein:

R³¹ and R³² are each as described above, and

R³⁴ is a moiety having a site of ethylenic unsaturation.

In one embodiment, the compound according to structure (A.III) is an α-, β-unsaturated carbonyl compound. In one embodiment, R³⁴ is according to structure (A.IV):

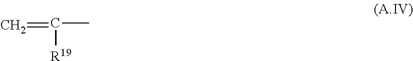

wherein R¹⁹ is H or (C₁-C₄)alkyl.

Suitable acidic monomers include, for example, ethylenically unsaturated carboxylic acid monomers, such as acrylic acid and methacrylic acid, ethylenically unsaturated dicarboxylic acid monomers, such as maleic acid and fumaric acid, ethylenically unsaturated alkyl monoesters of dicarboxylic acid monomers, such as butyl methyl maleate, ethylenically unsaturated sulphonic acid monomers, such as vinyl sulfonic acid 2-acrylamido-2-methylpropane sulfonic acid, and styrene sulfonic acid, and ethylenically unsaturated phosphonic acid monomers, such as vinyl phosphonic acid and allyl phosphonic acid, salts of any thereof, and mixtures of any thereof. Alternatively, corresponding ethylenically unsaturated anhydride or acid chloride monomers, such as maleic anhydride, may be used and subsequently hydrolyzed to give a pendant moiety having two acid groups. The preferred acidic monomeric units are derived from one or more monomers selected from acrylic acid, methacrylic acid, and mixtures thereof. Methacrylic acid has the following formula A.V:

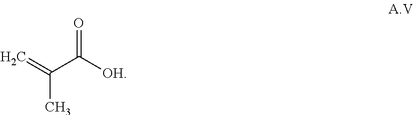

### Non-Ionic Monomers

In one embodiment, the additional nonionic monomeric units each independently comprise, per monomeric unit, at least one group according to structure (B.I):

—R⁴²—R⁴¹ (B.I)

wherein
R⁴¹ is alkyl, hydroxyalkyl, alkoxyalkyl, cycloalkyl, aryl, arylalkyl, or aryloxy, and
R⁴² is absent or is a bivalent linking group.

In one embodiment, R⁴¹ is (C₁-C₂₂)alkyl, (C₁-C₂₂)hydroxyalkyl, (C₂-C₂₂)alkoxyalkyl, (C₆-C₂₄)cycloalkyl, (C₆-C₄₀)aryl, or (C₇-C₄₀)arylalkyl, more typically (C₂-C₁₂)alkyl.

In one embodiment, R⁴¹ is (C₁-C₂₂)alkyl, more typically, (C₁-C₁₂)alkyl.

In one embodiment, R⁴² is O, —(CH₂)ₙ—O—, wherein n is an integer of from 1 to 6, or is according to structure (B.II):

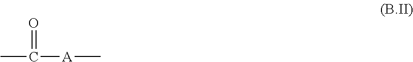

wherein
n is an integer of from 1 to 6,

### A is O or NR¹⁷, and

R¹⁷ is H or (C₁-C₄)alkyl.

The nonionic monomeric units may be made by known synthesizing techniques, such as, for example, by grafting of one or more groups according to structure (B.I) onto a polymer backbone, such as a hydrocarbon polymer backbone, a polyester polymer backbone, or a polysaccharide polymer backbone, or a backbone made by polymerization with, for example, the above described acidic monomers and hydrophobic monomers, and at least one other monomer selected from monomers comprising a reactive functional group and at least one group according to structure (B.I) per molecule. Alternatively, the nonionic monomeric units may simply be non-grafted portions of a polymer backbone.

In one embodiment, the nonionic monomeric units are derived from a nonionic monomer, for example, ethyl acrylate, comprising a reactive functional group and a group according to structure (B.I), and copolymerizable with the acidic monomers and hydrophobic monomers.

In one embodiment, the reactive functional group of the nonionic monomer is an ethylenically unsaturated group and the nonionic monomer is an ethylenically unsaturated monomer comprising at least one site of ethylenic unsaturation, more typically, an α-, β-unsaturated carbonyl moiety and at least one group according to structure (B.I) per molecule.

In one embodiment, the nonionic monomer comprises one or more compounds according to structure (B.III):

R⁴³—R⁴²—R⁴¹ (B.III)

wherein:

R⁴¹ and R⁴² are each as described above, and
R⁴³ is a moiety having a site of ethylenic unsaturation.

In one embodiment, the compound according to structure (B.IIII) is an α-, μ-unsaturated carbonyl compound. In one embodiment, R⁴³ is according to structure (B.IV):

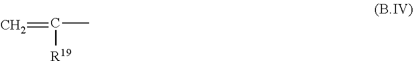

wherein R¹⁹ is H or (C₁-C₄)alkyl.

Suitable nonionic monomers include unsaturated monomers containing at least one group according to structure D.I per molecule, including (meth)acrylic esters such as: methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, hydroxyethyl (meth)acrylate, hydroxypropyl (meth)acrylate, methoxyethyl (meth)acrylate, ethoxyethyl (meth)acrylate, phenoxyethyl (meth)acrylate, tetrahydrofurfuryl (meth)acrylate, glycidyl (meth)acrylate, dimethylaminoethyl (meth)acrylate, diethylaminoethyl (meth)acrylate, tert-butylaminoethyl (meth)acrylate, and acetoxyethyl (meth)acrylate, (meth)acrylamides such as, (meth)acrylamide, N-methylol (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, and diacetone (meth)acrylamide, vinyl esters such as vinyl acetate, vinyl propionate, vinyl 2-ethylhexanoate, N-vinylamides such as: N-vinylpyrrolidione, N-vinylcaprolactam, N-vinylformamide, and N-vinylacetamide, and vinyl ethers such as, methyl vinyl ether, ethyl vinyl ether, butyl vinyl ether, and hydroxybutyl vinyl ether, and ethylenically unsaturated aryl compounds, such as styrene.

A method for the preparation of self-assembled particles induced macromolecular polymeric emulsifier by RAFT, characterized by comprising the steps of: (1) in two different hydrophilic and hydrophobic monomers as the raw material, is formed by amphiphilic molecules RAFT polymerization; (2) amphiphilic macromolecular chain transfer agent and a crosslinking agent RAFT polymerization reaction solvent, use of a crosslinking agent after crosslinking the polymeric core formed by the difference in solvent solubility directly induce the formation of colloidal particles, the reaction solution was dialyzed to remove unreacted monomers, to obtain colloidal particles dispersion; (3) to the dispersion of step (2) of the colloidal particles obtained as aqueous phase, and the oil phase were mixed by a volume ratio,

Polymer Compositions

In one embodiment, the latex polymer composition is in the form of an aqueous polymer dispersion, typically having a solids content including the polymer and any surfactants that may be present and based on the total weight of the polymer dispersion, of up to about 60 wt % and, more typically about 20 to about 50 wt %.

### EXPERIMENTS

### Example 1 (S1341-100)

De-ionized water and the Macro CTA, PAM-Xa (Polyacrylamide xanthate, 42% solids) (51.5 g) [8% based on total monomer], were added to a suitable reactor for emulsion polymerization equipped with agitation, heating and cooling means with a slow continuous nitrogen purge. Under continuous agitation, the temperature of the reactor was raised to constant temp, and a monomer mixture (13.5 g) [5.0% of a total 272.5 g of the monomer prepared by mixing of vinyl acetate, butyl acrylate, and acrylic acid] was added to the reactor.

Once the temperature of the reactor had stabilized, a solution of sodium metabisulphite [20% of the total solution of sodium metabisulphite (0.235 g) and sodium bicarbonate dissolved in deionized water] was added to the reactor. Five minutes later, a solution of ammonium persulfate [20% of the total solution of ammonium persulfate (0.582 g) dissolved in deionized water was added.

The seed was kept at 35° C. for 40 minutes. There was no observable change in color (bluish); however a slight exotherm of 1-2° C. was noticeable. A small sample was removed to check for particle size. The continuous addition of the remaining monomer mixture (259.0 g) was set to finish in 3 hours and 30 minutes. A total of 3 ml of FeCl3 solution was added to the reactor 40 minutes into monomer additions at reactor temperature. An exotherm of 2° C. was observed.

An hour into the addition of monomers and initiators, the temperature of the reactor was slowly raised during 3 hours to greater than 50° C. At the end of the monomer and initiators additions, the temperature of the reactor was increased slowly over at least 30 minutes. There was noticeable increased in exotherm at 65° C. The reactor was cooled below 40° C. and the resulting latex was filtered through a 136 um polyester filter.

The polymer dispersion obtained had a solid content of 44.34%, and the average particle size was 121.7 d.nm.

### Comparative Example 1 (S1336-68)

Deionized water (107.5 g), sodium C14-C16 olefin sulfonate surfactant (2.5 g) [0.40% based on the total monomer], and sodium bicarbonate (0.1 g) were added to a suitable reactor for emulsion polymerization equipped with agitation, heating and cooling means with a slow continuous nitrogen purge. Under continuous agitation, the temperature of the reactor was raised to 72.0° C. At 72.0° C., a monomer pre-emulsion (10.80 g) [3.0% of a total 360.12 g of monomer pre-emulsion was prepared by mixing deionized water (100 g), sodium C14-C16 olefin sulfonate surfactant (9.37 g), sodium bicarbonate (0.75 g), vinyl acetate, butyl acrylate, and acrylic acid] was added to the reactor (the pre-emulsion was stabilized before adding), followed by a solution of ammonium persulfate.

The seed was kept for 15 minutes. A small sample was removed to check for the particle size. The continuous addition of the remaining monomer pre-emulsion (349.3 g) was set to finish in 3 hours and 50 minutes and the continuous addition of the remaining initiator solution was set to finish in 4 hours. The resulting latex was filtered using 136 um polyester filter.

The polymer dispersion obtained had a solid content of 47.89%, the average particle size was 103.3 d.nm and a pH of 4.95.

### Comparative Example 2

Encor™ 310 (obtained from Arkema) is a commercial vinyl acrylic binder used as a control (comparative example 2)

| | Particle | | | | |
|---|---|---|---|---|---|
| Example | Size, d · nm | Solids, % | pH | coagulum | Viscosity |
| Example 1 | 121.7 | 44.34 | 4.94 | 0.114 | 549.0 |
| Comparative | 103.3 | 47.89 | 4.95 | 0.01 | 3040 |
| example 1 | | | | | |
| Comparative | 300 | | | | |
| example 2 | | | | | |

Paint Formulation:

The latex sample prepared from example 1, Comparative example 1, and Comparative example 2 were prepared as architectural paints. The paint formulation was given in the following table 1.

TABLE 1
Paint formulation

| | | Comparative | Comparative |
|---|---|---|---|
| Raw Material | Example 1 | example 1 | example 2 |
| Pigment Grind | | | |
| Water | 10.76 | 10.76 | 10.76 |
| Natrosol Plus 330 | 0.13 | 0.13 | 0.13 |
| AMP-95 | 0.12 | 0.12 | 0.12 |
| Acticide BW-20 | 0.18 | 0.18 | 0.18 |
| Dispersant | 0.63 | 0.63 | 0.63 |
| Defoamer | 0.18 | 0.18 | 0.18 |
| Wetting agent | 0.27 | 0.27 | 0.27 |
| CaCO3 #10 white | 10.76 | 10.76 | 10.76 |
| Kaolin | 5.65 | 5.65 | 5.65 |
| Organic Clay | 0.36 | 0.36 | 0.36 |
| Letdown | | | |
| Ti-Pure R-746 | 23.31 | 23.31 | 23.31 |
| Water | 6.53 | 6.53 | 6.53 |
| Latex Resins | 32.73 | 32.73 | 32.73 |
| Coalescent | 1.35 | 1.35 | 1.35 |
| AMP-95 | 0.05 | 0.05 | 0.05 |
| Defoamer | 0.27 | 0.27 | 0.27 |
| Thickner | 0.13 | 2.39 | 3.14 |
| Water | 5.24 | 4.33 | 3.58 |
| Total | 100 | 100 | 100 |
| Properties: | | | |
| PVC, % | 40.46 | | |

The liquid paint properties were measured in the following table 2.

TABLE 2
Liquid Paint Performance Properties

| | | Comparative | Comparative |
|---|---|---|---|
| Samples | Example 1 | example 1 | example 2 |
| Initial properties | | | |
| KU viscosity | 105 | 100.2 | 101.1 |
| ICI viscosity, poise | 1.2 | 1.6 | 1.4 |
| pH | 8.61 | 9.12 | 9.02 |
| Equilibrated | | | |
| properties | | | |
| KU viscosity | 119 | 110 | 125/121 |
| ICI viscosity, poise | 2.1 | 1.8 | 1.34 |
| pH | 8.28 | 9.34 | 9.01 |

Dry paint performance was further evaluated and the properties were given in table 3.

TABLE 3
Properties of Dry Paint

| | | Comparative | Comparative |
|---|---|---|---|
| Samples | Example 1 | example 1 | example 2 |
| Gloss, 60° | 5.0 | 5.0 | 5.0 |
| Sag | 24 | 12 | 12 |
| Flow | 3 | 7 | 8 |
| Opacity-Hidding | 97.85 | 97.21 | 96.59 |
| Block Resistance | | | |
| 1 day, RT/Oven | 10/7 | 10/2 | 6/2 |
| 7 days, RT/Oven | 10/9 | 10/6 | 9/4 |
| Stain Test | | | |
| % removed hydrophobic | 58.33 | 20.83 | 45 |
| % removed hydrophilic | 81.25 | 72.5 | 37.5 |
| Scrub Resistance | | | |
| 1^{st} cut | 129-144 | 351-372 | 2245-2400 |
| 50% cut | 184-191 | 524-572 | N/A |

### Example 2 (2.5% PAA-XA)

Deionized water and the macro CTA pAA-Xa (Polyacrylic acid xanthate, 40.37% solids) [1.1% based on the total monomer] were mixed under high agitation and neutralized to a pH of 6.20 with a solution of ammonium hydroxide (20% solution). The mixture was added to a suitable reactor for emulsion polymerization equipped with agitation, heating and cooling means and a slow continuous nitrogen purge. Under continuous agitation, the temperature of the reactor was raised and a monomer mixture [monomer prepared by mixing of vinyl acetate and butyl acrylate] was added to the reactor. Once the temperature of the reactor had stabilized, a solution of ammonium persulfate was added to the reactor. Blue coloration was observed within five minutes.

The seed was kept at constant temp for 30 minutes. A small sample was removed to check for particle size. The remaining monomers were continuously fed in 3 hours along with a macro CTA feed [1.4% based on the total monomer prepared by mixing pAA-Xa (40.37% solids) and deionized water with ammonium hydroxide set to complete in 1 hour 30 minutes.

When the monomer addition was finished, a small sample of aqueous polymer dispersion was obtained to do a solid content. If the solid content has reached to theoretical solid, then the reaction was cooled to about 40° C., and the resulting latex was filtered through a 136 um polyester filter.

The polymer dispersion obtained had a solid content of 42.57%, the average particle size was 159.3 d.nm and a pH of 5.70.

### Example 3 (PAM-PAA-XA)

Deionized water (295.2 g) and macro CTA PAM-PAA-XA (Copolymer, 34.20% solids)(6.0 g) [1.00% based on the total monomer] were mixed under high agitation and neutralized to a pH of 6.09 with a solution of ammonium hydroxide (20% solution). The mixture was added to a suitable reactor for emulsion polymerization equipped with agitation, heating and cooling means and a slow continuous nitrogen purge. Under continuous agitation, the temperature of the reactor was raised to 68° C. At 68° C., a monomer mixture (13.0 g) [6.5% of a total 200 g of the monomer prepared by mixing of vinyl acetate (160.0) and butyl acrylate (40 g)] was added to the reactor. Once the temperature of the reactor had stabilized to 68° C., a solution of ammonium persulfate [0.08% based on total monomer prepared by dissolving ammonium persulfate (0.18 g) in deionized water (2.23 g)] was added to the reactor. Blue coloration was observed within five minutes.

The seed was kept at 68° C. for 40 minutes. A small sample was removed to check for particle size. The remaining monomers (187.0 g) were continuously fed in 3 hours and 40 minutes.

When the monomer addition was finished, a small sample of aqueous polymer dispersion was obtained to do a solid content. If the solid content has reached to theoretical solid, then the reaction was cooled to about 40° C., and the resulting latex was filtered through a 136 um polyester filter. If the solid content was not at the theoretical solid, then the aqueous polymer dispersion was further reacted until the theoretical solid is reached.

For this particular example, the latex polymer dispersion was further heated for an hour at temperature 68° C. before cooling it to 40° C., and the resulting latex was filter using 136 um polyester filter.

The polymer dispersion obtained had a solid content of 39.97%, the average particle size was 140.2 d.nm and a pH of 5.16.

### Comparative Example 3 (S1403-138)

Deionized water (102.0 g) and Rhodapex EST 30 (3.32 g) [sodium tridecyl ether sulfate, 3 moles of EO (30.0% actives)] [0.40% based on the total monomer] were added to a suitable reactor for emulsion polymerization equipped with agitation, heating and cooling means with a slow continuous nitrogen purge. Under continuous agitation, the temperature of the reactor was raised to 35° C. At 35° C., a monomer pre-emulsion (19.0 g) [5.0% of a total 372.45 g of monomer pre-emulsion was prepared by mixing deionized water (104.0 g), Rhodapex EST 30 (12.45 g), sodium bicarbonate (0.38 g), vinyl acetate (197.5 g), butyl acrylate (55.6 g), and acrylic acid (2.5 g)] was added to the reactor (the pre-emulsion was stabilized before adding). Then a solution of sodium metabisulfite (6.05 g) [20.0% of the total solution of sodium metabisulfite (0.23 g) dissolved in deionized water (30.0 g)] was added to the reactor, followed by a solution of ammonium persulfate (6.10 g) [20.0% of the total solution of ammonium persulfate (0.50 g) dissolved in deionized water (30.0 g)]. Light blue color was observed after the addition of initiators.

Five minutes after the seed addition, the temperature of the reactor was increased 54.0° C., and the seed was kept at 54.0° C. for 25 minutes. A small sample was removed to check for the particle size before monomer and initiators feeds.

The continuous addition of the remaining monomer pre-emulsion was finished in 4 hours, and the remaining solutions of ammonium persulfate and sodium metabisulfite were finished in 4 hours and 15 minutes.

The solid content after the monomer and initiator feeds was 30.37%, and the temperature of the reactor was increased to 62.0° C. The resulting latex was further heated for two and half hours before cooling it to 40° C. and it was filtered using 136 um polyester filter.

The polymer dispersion obtained had a solid content of 46.92%, the average particle size was 121.4 d.nm and a pH of 5.67.

TABLE 4
Latex Characterization

| | Particle | | | | |
|---|---|---|---|---|---|
| Example | Size, d · nm | Solids, % | pH | Coagulum, % | Viscosity |
| Example 2 | 144.9 | 43.99 | 5.62 | 0.0 | 6700 |
| example 3 | 140.2 | 39.97 | 5.16 | 0.00 | 3340 |
| Comparative | 121.4 | 40.73 | 5.7 | 0.092 | 1390 |
| example 3 | | | | | |

Paint Formulation

The latex sample prepared from example 2, example 3, and comparative example 3 were prepared as architectural paints. The paint formulation was given in the following table 5.

TABLE 5
Paint Formulation

| | | | Comparative |
|---|---|---|---|
| Raw materials | Example 2 | Example 3 | example 3 |
| Pigment Grind | | | |
| Water | 10.77 | 10.77 | 10.77 |
| Natrosol Plus 330 | 0.13 | 0.13 | 0.13 |
| AMP-95 | 0.13 | 0.13 | 0.13 |
| Dispersant | 0.63 | 0.63 | 0.63 |
| Deformer | 0.18 | 0.18 | 0.18 |
| Rhodoline WA265N | 0.36 | 0.36 | 0.36 |
| CaCO3 #10 white | 10.77 | 10.77 | 10.77 |
| Kaolin | 5.65 | 5.65 | 5.65 |
| Attagel 50 | 0.36 | 0.36 | 0.36 |
| | 28.98 | | |
| Letdown | | | |
| Ti-Pure R-746 | 23.33 | 23.33 | 23.33 |
| Water | 8.3 | 8.3 | 8.3 |
| Latex Resins | 32.75 | 32.75 | 32.75 |
| Coalescent | 1.79 | 1.79 | 1.79 |
| Ammonia (28%) | 0.09 | 0.09 | 0.09 |
| Defoamer | 0.27 | 0.27 | 0.27 |
| Thickner ICI | 0 | 0.16 | 1.08 |
| Thickner KU | 0 | 0 | 0.72 |
| Water | 4.49 | 4.33 | 2.69 |
| | 71.02 | | |
| Total | 100 | | |
| Properties | | | |
| PVC, % | 40.46 | | |

The liquid paint properties were measured in the following table 6.

TABLE 6
Liquid Paint Performance Properties

| | | | Comparative |
|---|---|---|---|
| Samples | Example 2 | Example 3 | example 3 |
| Initial properties | | | |
| KU viscosity | 90.2 | 108 | 84.1 |
| ICI viscosity, poise | 0.331 | 0.787 | 1.871 |
| pH | 8.92 | 9.24 | 8.63 |
| Equilibrated | | | |
| properties | | | |
| KU viscosity | 97.6 | 120.6 | 93.8 |
| ICI viscosity, poise | 0.554 | 0.963 | 1.546 |
| pH | 8.95 | 8.98 | 8.61 |

Dry paint performance was further evaluated and the properties were given in table 7.

TABLE 7
Properties of dry paint

| | | | Comparative |
|---|---|---|---|
| Samples | Example 2 | Example 3 | example 3 |
| Gloss, | 5.1 | 4 | 4.4 |
| 60° | | | |
| Sag | 18 | 18 | 20 |
| Flow | 6 | 2 | 2 |
| Opacity-Hiding | 97.89 | 97.13 | 97.4 |
| Block Resistance | | | |
| day, RT/Oven | 10/10 | 10/8 | 9/6 |
| Stain Resistance, % | 46 | 58 | 42 |
| Adhesion, black chart | 5B/5B | 5B/5B | 5B/5B |
| Wet/Dry | | | |
| Scrub Resistance | | | |
| 1^{st} cut | >5000 | >5000 | 720 |
| 50% cut | N/A | N/A | N/A |

### Example 4

First step has been to re-run the seed synthesis in a 1 liter jacketed reactor in order to have a better vision of temperature & reflux evolution. Two synthesis had been run at half (500 g—16FTI013) and full charge (1000 g—16FTI016).

Key Parameter

Solid: 15%

Ratio Macromonomer/Polymer: 15.70% pAm/(pAm+VA)

T jacket: 68° C. (constant along run)

### Example 5: pAM-5k-Xa (Polyacrylamide (with Mw of 5000)—Xanthate)

TABLE 8
polyacrylamide (Mw of 5000) - Xanthate recipe

| | Charges | | | |
|---|---|---|---|---|
| 16FTI040 | (g) | | | |
| Macro CTA | | p-AM-Xa | | Rpm = 250 |
| | | 16EVN087 | | Stirrer = 12 blades |
| | | Mn = 5000 | | Reactor size = 105 mm |
| | | Dry % | 41.9 | |
| Theoretical Dry % of | | 19.50% | | |
| Recipe | | | | |
| | | Solid | pHM | |
| Kettle Charge | | | | |
| Water | 600 | | | |
| Macro CTA | 250 | 104.75 | | |
| AVM | 80 | 80 | | |
| Water (shot) | 10 | | | |
| Amm Pers. | 1.28 | 1.28 | 1.6 | |
| Chaser | | | | |
| Water | 10 | | | |
| Amm Pers | 0.16 | 0.16 | 0.2 | |
| Total | 951.44 | 186.19 | | |
| Solid % | | 19.57 | | |
| Seed/Polymer | | 56.70 | | |
| % AVM in | | 0 | | |
| kettle | | | | |

Charge water and macromonomer solution, Bubble N2

Pass to blanket, ad AVM, set Tjacket at 67° C. (to get T int around 63-64° C.)

Keep jacket at 67° C. all along the run

Pass to blanket and shot I, than follow reaction profile

Chaser before cooling

Optional redox chaser not run here

Optional buffering not used here

Kinetic profile can depend on synthesis process adopted for MacroCTA preparation,

Time up to 120′ to reach the peak not unexpected

### Additional Examples

The recipes listed below are similar to the aforementioned, where the difference is the amount of initiator and the type of Macro CTA that instead of being based on pAM it is based on:

Acrylaride and Acrylic Acid >p(AM-AA), usually still at 5,000 Mw with ratio 80/20 and 60/40.

VA/BA/AA is Vinyl Acetate/Butyl Acrylate and Acrylic Acid at a ratio of 80/19/1

TABLE 9

| | | | | | |
|---|---|---|---|---|---|
| | Form. 1 | Form. 2 | Form. 4 | Form. 5 | Form. 6 |
| | AEDD011 | AV439 | 17FTI014 | 17FTI017 | 17FTI033 |
| Date | VA/BA/AA | V/A/V10 | AM/AA | AM/AA | AM/AA |

| | | | | |
|---|---|---|---|---|
| Monomer Ratio | 80/19/1 | 80/20 | 80/20 | 80/20 |
| Macro CTA: AM/AA | | 60/40 | 60/40 | 80/20 |
| % AA in final polymer | 1 | 0.58 | 1.27 | 0.31 |
| % MacroCTA/polymer | | 1.46 | 3.18 | 1.54 |
| Seeding Process | | Ext | Ext | In Situ |

Measurables

| Krebs KU | | 103.5 | 88 | 90.1 | 89.1 | 95 |
|---|---|---|---|---|---|---|
| BYK | | 266 | 225 | 169 | 173 | 214 |
| Brookfield | 20 | 5860 | 3340 | 5180 | 5200 | 6220 |
| | 50 | 3800 | 2224 | 2808 | 2760 | 3400 |
| | 100 | 1983 | 1648 | 1856 | 1792 | 2140 |
| pH | | 8.87 | 8.73 | 8.63 | 8.36 | 8.53 |
| Density | | 1.62 | 1.61 | 1.61 | 1.62 | 1.61 |
| Scrub. | | 43.46 | 37 | 13.99 | 15.68 | 20.26 |
| Scrub 1j TA + 1J 50° C. + 1j | | 44.94 | 48.82 | 15.24 | 18.41 | 26.12 |
| TA | | | | | | |
| Extrait sec (%) | | 63.8 | 64.2 | 63.9 | 64.3 | 64.1 |
| Block test | | | | | | |
| Temps ouvert (min) | | 19 | 19 | 13 | 15 | 14+ |
| Application J + 1, mesure J + 2 | | | | | | |
| Gloss (20°-60°-85°) | | 1,3-2,3- | 1,3-2,3- | 1,3-2,3- | 1,3-2,2- | 1,3-2,2- |
| | | 1,9 | 2,9 | 1,6 | 1,5 | 1,6 |
| Observations | | | | | | |
| Opacity (Yb/Yw) % | | 1.00 | 0.96 | 0.95 | 1.00 | 0.98 |
| Stability Measurement/ | | | | | | |
| 40° C. | | | | | | |
| Synérèse | | 1 cm | 1 cm | 1 cm | 1 cm | 1 cm |
| Observations | | | | | | |
| Krebs | | 102.2 | 80.6 | 87.6 | 83.9 | 87.6 |
| BYK | | 270 | 187 | 244 | 281 | 169 |
| Brookfield | 20 | 5380 | 2840 | 3240 | 4680 | 5120 |
| | 50 | 3624 | 1872 | 2632 | 2456 | 2840 |
| | 100 | 2772 | 1380 | 1836 | 1588 | 1872 |

| | | | | | |
|---|---|---|---|---|---|
| pH | 8.35 | 8.36 | 8.42 | 8.2 | 8.42 |

### Example 100

Latex polymers with modified surface chemistry samples were prepared through macro-CTA technology (PISA) and architectural paints were formulated. The paint formulation was given in the following Table 100. A comparative latex sample was made through regular surfactant technology and similar architectural paint was also formulated.

TABLE 100
Flat paint formula

| | Latex 1 | Latex 2 | Latex from |
|---|---|---|---|
| Raw materials | from PISA | from PISA | surfactant |
| Pigment Grind | | | |
| Water | 10.89 | 10.89 | 10.89 |
| AMP-95 | 0.12 | 0.12 | 0.12 |
| Acticide BW-20 | 0.18 | 0.18 | 0.18 |
| Dispersant | 0.63 | 0.63 | 0.63 |
| Defoamer | 0.18 | 0.18 | 0.18 |
| Wetting Agent | 0.27 | 0.27 | 0.27 |
| CaCO3 | 10.76 | 10.76 | 10.76 |
| Kaolin | 5.65 | 5.65 | 5.65 |
| Organic clay | 0.36 | 0.36 | 0.36 |
| | 29.04 | 29.04 | 29.04 |
| Letdown | | | |
| Ti-Pure R-746 | 23.31 | 23.31 | 23.31 |
| Water | 6.53 | 6.53 | 6.53 |
| Latex resin | 32.73 | 32.73 | 32.73 |
| Coalescent | 1.35 | 1.35 | 1.35 |
| AMP-95 | 0.05 | 0.05 | 0.05 |
| Defoamer | 0.27 | 0.27 | 0.27 |
| Thickener | 0.76 | 0 | 2.39 |
| Ammonia | 0.16 | 0.16 | 0 |
| Water | 5.8 | 6.56 | 4.33 |
| Total | 100 | 100 | 100 |
| Properties: | | | |
| PVC, % | 40.46% | | |

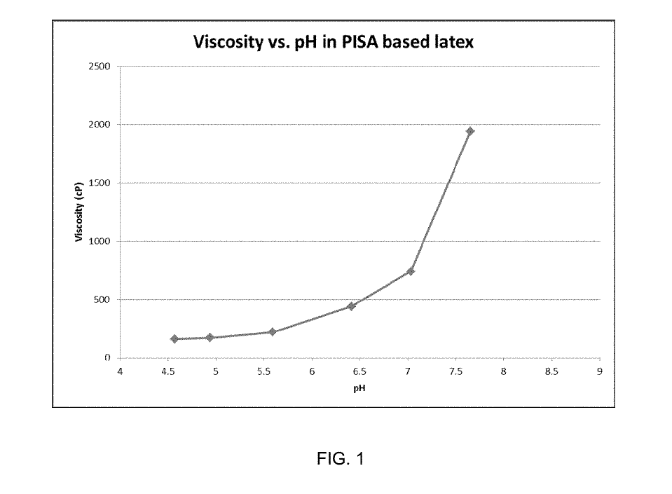

The latex sample under Example 100 was prepared through macro-CTA technology (PISA); the viscosity of latex versus pH was measured and the results are given in the following FIG. 1. FIG. 1 shows that the viscosity of the latex increased significantly when pH was adjusted to above 7. This self-thickening property would allow paint formulator to formulate paint to reach the desired viscosity without using additional thickeners.

The liquid paint properties were measured in the following Table 101. The latex paints based on PISA technology clearly showed self-thickening properties and there is no need extra thickeners to reach the desired viscosity and rheology profile of the paint.

TABLE 101
Liquid Paint Performance Properties

| | Latex 1 | Latex 2 | Latex from |
|---|---|---|---|
| Samples | from PISA | from PISA | surfactant |
| Initial properties | | | |
| KU viscosity | 119.4 | 105 | 100.2 |
| ICI viscosity, poise | 2.1 | 1.6 | 1.6 |
| pH | 8.2 | 8.61 | 9.12 |
| Equilibrated properties | | | |
| KU viscosity | 141 | 119 | 110 |
| ICI viscosity, poise | 2.1 | 2.1 | 1.8 |
| pH | 8.31 | 8.28 | 9.34 |

Dry paint performance was further evaluated and the properties were given in the following Table 102. The latex paints based on PISA technology also showed improved block resistance (especially at elevated temperature) and stain resistance.

TABLE 102
Dry Paint Performance Properties

| | Latex 1 | Latex 2 | Latex from |
|---|---|---|---|
| Samples | from PISA | from PISA | surfactant |
| Appearance of paint | 5 | 5 | 5 |
| Gloss, 60° | 4.4 | 4.7 | 4.9 |
| Opacity -Hidding | 97.34 | 97.85 | 97.21 |
| Color acceptance, ΔE | 0.08 | 0.19 | 0.11 |
| Block resistance | | | |
| 1 day, RT/Oven | 10/8 | 10/7 | 10/2 |
| 7 day, RT/Oven | 10/9 | 10/9 | 10/6 |
| Stain resistance | 54% | 68% | 41% |

It should be apparent that embodiments and equivalents other than those expressly discussed above come within the spirit and scope of the present invention. Thus, the present invention is not limited by the above description but is defined by the appended claims.

What is claimed is:

1. A coating composition comprising: a latex composition with modified surface chemistry obtained by free-radical emulsion polymerization in the presence:
of at least one ethylenically unsaturated monomer or at least one polymer containing residual ethylenically unsaturated bonds comprising: methyl acrylate, ethyl acrylate, methyl methacrylate, butyl acrylate, 2-ethyl hexyl acrylate, acrylic acid, methacrylic acid, styrene, vinyl toluene, vinyl acetate, vinyl versatate, ethylene vinyl acetate (VAE), acrylonitrile, acrylamide, butadiene, ethylene, vinyl chloride, and mixtures thereof,
of at least one free-radical polymerization initiator, and
of at least one water-soluble and/or water-dispersible monoblock, diblock or triblock polymer comprising formula (I):
(R¹¹)x-Z¹¹—C(═S)—Z¹²-[A]-R¹² (I)
wherein:
Z¹¹ represents C, N, O, S or P,
Z¹² represents S or P,
R¹¹ and R¹², which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R respresenting an alkyl or aryl group,
x corresponds to the valency of Z¹¹, or alternatively x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR₂); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts); and A represents a monoblock, diblock or triblock polymer comprising at least a first block which is hydrophilic in nature and an optional second block which is hydrophobic or hydrophilic in nature,
wherein the coating composition is substantially free of added rheology modifiers.

2. The coating composition of claim 1 wherein the coating composition is an aqueous colloidal dispersion having a viscosity of less than or equal to 65 KU at a pH lower than about 5.0 but having an increased viscosity upon adjustment to a pH of about 5.5 or higher.

3. The coating composition of claim 1 wherein the coating composition is an aqueous colloidal dispersion having a viscosity of less than or equal to 70 KU at a pH lower than about 5.0 but having viscosity of greater or equal to 85 KU upon adjustment to a pH of about 6.5 or higher.

4. The coating composition of claim 1 wherein the coating composition is an aqueous colloidal dispersion having a viscosity of less than or equal to 65 KU at a pH lower than about 5.0 but having viscosity of greater or equal to 95 KU upon adjustment to a pH of about 6.5 or higher.

5. The coating composition of claim 1 wherein the at least one ethylenically unsaturated monomer comprises vinyl acetate, ethylene vinyl acetate (VAE), and mixtures thereof.

6. The coating composition of claim 5 wherein the at least one ethylenically unsaturated monomer further comprises at least one second monomer selected from: methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, hydroxyethyl (meth)acrylate, hydroxypropyl (meth)acrylate, methoxyethyl (meth)acrylate, ethoxyethyl (meth)acrylate, phenoxyethyl (meth)acrylate, tetrahydrofurfuryl (meth)acrylate, glycidyl (meth)acrylate, dimethylaminoethyl (meth)acrylate, diethylaminoethyl (meth)acrylate, tert-butylaminoethyl (meth)acrylate, and acetoxyethyl (meth)acrylate, (meth)acrylamide, N-methylol (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, and diacetone (meth)acrylamide, vinyl propionate, vinyl 2-ethylhexanoate, N-vinylpyrrolidione, N-vinylcaprolactam, N-vinylformamide, N-vinylacetamide, methyl vinyl ether, ethyl vinyl ether, butyl vinyl ether, hydroxybutyl vinyl ether, styrene, maleic acid, fumaric acid, butyl methyl maleate, vinyl sulfonic acid, 2-acrylamido-2-methylpropane sulfonic acid, styrene sulfonic acid, vinyl phosphonic acid, allyl phosphonic acid, salts thereof, and mixtures thereof.

7. The coating composition of claim 1 further comprising at least one additive selected from the group consisting of dispersants, defoamers, biocides, mildewcides, colorants, waxes, perfumes and co-solvents.

8. The coating composition of claim 1 wherein the at least one water-soluble and/or water-dispersible monoblock, diblock or triblock polymer comprising formula (I) has a weight average molecular weight of from 5,000 to 7,000.

9. A process for preparing an aqueous polymer dispersion, the process comprising free radical polymerizing ethylenically unsaturated monomers in the presence of at least one free radical initiator and at least one compound of formula (I) in an aqueous polymerization medium;
wherein the aqueous polymer dispersion is substantially free of added rheology modifiers,
wherein the aqueous polymer dispersion is characterized by a viscosity of less than or equal to 70 KU at a pH lower than about 5.0, but a viscosity of greater or equal to 85 KU upon adjustment to a pH of about 6.5 or higher.

10. The process of claim 9 wherein the aqueous polymer dispersion is characterized by a viscosity of less than or equal to 65 KU at a pH lower than about 5.0, but a viscosity of greater or equal to 90 KU upon adjustment to a pH of about 6.5 or higher.

11. The process of claim 9 wherein the aqueous polymer dispersion is a latex polymer dispersion, the latex polymer comprising:
(a) a first monomer selected from vinyl acetate or ethylene vinyl acetate (VAE); and
(b) at least one second monomer different from the first monomer.

12. The process of claim 9 wherein the aqueous polymer dispersion is a latex polymer dispersion, the latex polymer comprising:
(a) a first monomer selected from vinyl acetate; and
(b) at least one second monomer selected from: acrylic acid, methacrylic acid, maleic acid, fumaric acid, butyl methyl maleate, vinyl sulfonic acid, 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

13. The process of claim 9 wherein the at least one compound of formula (I) has a weight average molecular weight of from 5,000 to 7,000.

14. The coating composition of claim 1 further comprising a pigment

15. The process of claim 9 wherein the aqueous polymer dispersion further comprises a pigment.
